(19) United States
(12) Patent Application Publication
(10) Pub. No.: US 2026/0300553 A1
(43) Pub. Date: Oct. 1, 2026

(54) AN OBFUSCATING PROCESS FOR QUANTUM CIRCUITS

(71) Applicant: Dell Products L.P., Round Rock, TX (US)

(72) Inventors: Miguel Paredes Quiñones, Campinas (BR); Diego Vrague Noble, Pelotas (BR); Ítalo Gomes Santana, Rio de Janeiro (BR)

(21) Appl. No.: 19/095,235

(22) Filed: Mar. 31, 2025

(51) Int. Cl. G06F 21/71

(52) U.S. Cl. CPC G06F 21/71

(57) ABSTRACT

Obfuscating quantum circuits is disclosed. A quantum circuit is transpiled to generate a transpiled quantum circuit based on settings of a target quantum processing unit. The transpiled quantum circuit is obfuscated by adding one or more near-identity blocks to generate an obfuscated quantum circuit. The obfuscated quantum circuit is executed and a final state suffices as a final state to the original quantum circuit. The near-identity circuits may include an original circuit that includes entanglements, rotational gates, and a complement of the original circuit. The near-identity circuits are merged into the transpiled quantum circuit.

### TECHNOLOGICAL FIELD OF THE DISCLOSURE

Embodiments disclosed herein generally relate to quantum circuits and to executing quantum circuits. More particularly, at least some embodiments relate to systems, hardware, software, computer-readable media, and methods for obfuscating quantum circuits.

### BACKGROUND

A code obfuscator is a utility used to convert a portion of code into a version that is difficult to read and comprehend. Code obfuscators are configured to make the process of reverse engineering more difficult while still allowing the underlying code to operate as intended. Obfuscating quantum circuits, in contrast, is more difficult due, in part, to the nature of generating and executing quantum circuits.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of obfuscating a quantum circuit;

FIG. 1B discloses additional aspects of obfuscating a quantum circuit;

FIG. 2 discloses aspects of generating near-identity blocks for obfuscating quantum circuits;

FIGS. 3A and 3B disclose aspects of obfuscating a quantum circuit that is subsequently delivered to a quantum computing unit for execution;

FIG. 4 discloses aspects of a method for obfuscating a quantum circuit; and

FIG. 5 discloses aspects of a computing device, system, or entity.

### DETAILED DESCRIPTION OF SOME EXAMPLE EMBODIMENTS

Embodiments disclosed herein generally relate to quantum circuits and to executing quantum circuits. More particularly, at least some embodiments relate to systems, hardware, software, computer-readable media, and methods for obfuscating quantum circuits.

Quantum circuits are executed by quantum processing units. When a quantum circuit is executed, the quantum circuit may be exposed (e.g., visible or accessible to others). This may impact the security of the quantum circuit. More specifically, quantum circuits provide advantages to their owners or developers and ensuring that a quantum circuit remains private is a significant concern, particularly because the quantum circuits may be revealed at execution time in cloud providers of quantum processing units. More specifically, quantum circuits are transmitted to external cloud providers, which raises privacy concerns regarding the quantum circuit and security concerns regarding the use of exposed quantum circuits for unauthorized purposes. Programming languages used to build quantum circuits do not have reliable obfuscating mechanisms. Consequently, obfuscating a quantum circuit is complicated for at least these reasons.

Embodiments of the invention thus relate to obfuscating quantum circuits. In one example, quantum circuit obfuscation is achieved by placing blocks of identity or near-identity subcircuits into the quantum circuit. Adding near-identity subcircuits (e.g., gates, multiple gates) increases the number of gates in the quantum circuit and may increase noise. As a result, high precision quantum hardware may provide improved results when executing the obfuscated quantum circuit. The addition of identity or near-identity subcircuits keeps the original functionality of the quantum circuit while obfuscating its global interpretation. This allows entities to offer services and utilities without revealing any secret in the form of a quantum circuit. For example, a quantum algorithm that presents or represents technological breakthroughs can be advantageously protected from unauthorized use and discovery.

Embodiments of the invention may generate an obfuscated quantum circuit (OQC) from a quantum circuit (QC). A QPU (Quantum Processing Unit) executes the OQC or QC. A transpiler is an example of software configured to modify a QC or OQC such that the QC or OQC satisfies QPU requirements. A QPU may be implanted in real quantum hardware, or in classical computing systems (e.g., an emulated QPU).

When generating an OQC, embodiments of the invention ensure that the OQC is equivalent or nearly equivalent to the original QC, while also ensuring that interpreting the OQC is challenging in order to protect its content. In one example, any input and output of a OQC should be close to the corresponding input and output of the corresponding QC. The amount of acceptable deviation can be selected by a user, by default, by threshold, or the like.

Embodiments of the invention ensure that the inputs/outputs of the QC and OQC are sufficiently close by establishing the generation of near-identity circuit blocks and their posterior inclusion into a QC. This may alter the outputs of the QPU.

To reduce the success of reverse engineering or de-obfuscating an obfuscated quantum circuit, the blocks (e.g., near-identity circuits) used to obscure the QC may be randomly placed into the code and may have random sizes. Thus, if the OQC is transmitted to an unauthorized user or entity, the unauthorized user does not have clear evidence of where the near-identity blocks are placed, the number of near-identity blocks placed, the sizes of the near-identity gates, or the patterns of the near-identity gates. Attempts to reverse engineer the OQC require running these circuit blocks multiple times in a QPU in order to verify whether a circuit block is a near-identity block by its distribution along with other processes to detect the near-identity blocks. This results in significant computational and cost burdens. As a consequence, de-obfuscation becomes impractical from a QPU usage demand perspective and from a cost perspective.

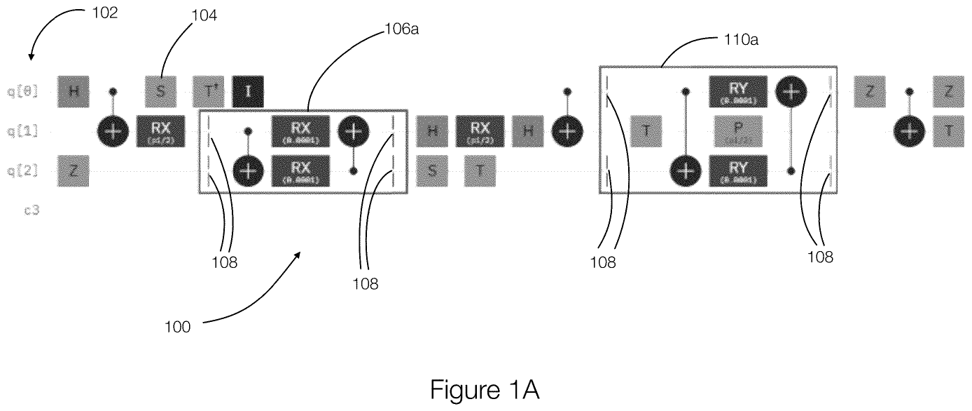

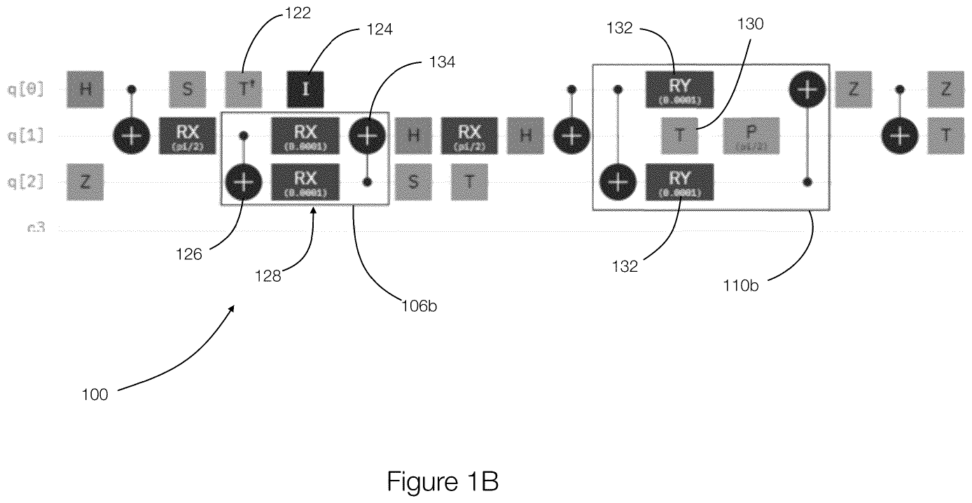

FIG. 1A discloses aspects of an obfuscating a quantum circuit. FIG. 1A illustrates a quantum circuit 100 that includes 3 qubits 102 (q0, q1, and q2). The quantum circuit 100 includes a variety of different gates represented by, for example, the gate 104. Example single qubit gates may include Pauli gates (e.g. X, Y, and Z gates), Hadamard gates, phase gates (e.g., S and T gates), and rotation gates. Examples of multi-qubit gates include CNOT gates, Toffoli gates, swap gates, and the like. RX and RY gates are examples of rotation gates around, respectively, the x and y axes.

In one example, obfuscating a quantum circuit includes adding or including identity or near-identity blocks 106a and 110a into the quantum circuit 100. In FIG. 1A, a barrier 108 is illustrated. Barriers are examples of separators that may prevent the transpiler from rearranging or optimizing certain gates. Thus, operations before and after the barrier 108 remain in their given order. In this example, the blocks 106a and 110a are added with barriers 108 initially to ensure that the execution of the quantum circuit 100 is not adversely impacted by the added blocks 106a and 110a.

FIG. 1B illustrates additional aspects of obfuscating a quantum circuit. In FIG. 1B, the near-identity blocks 106a and 110a are illustrated as blocks 106b and 110b. FIG. 1B illustrates obfuscation of the quantum circuit 100 as the obfuscation operation progresses. In this example, portions of the quantum circuit 100 have been rearranged as part of the obfuscation operation. For example, the controlled not gate 126 in the block 106b is aligned in the same layer as the gate 122 and the RX gates 128 is aligned in the same layer of the quantum circuit 100 as the gate 124. In the block 110b, the gate 130 is merged with the block 110b and included in the layer that includes the RY gates 132. The gate 130 can be merged into the block 110b at least because the gate 130 does not participate in the operations reflected in the near-identity block 110b. In other words, the gate 130 is merged into the space of the block 110b, but does not alter the behavior of the block 110b. FIG. 1B also illustrates that the barriers 108 have been removed. FIG. 1B illustrates an example a quantum circuit 100 that has been obfuscated.

In this example, the blocks 106b and 110b are near-identity blocks at least because the near-identity blocks generate a small divergence on a final equivalent unitary matrix. An identity matrix is a neutral element in matrix multiplication and does not alter the overall result. Embodiments of the invention may make a small alteration and this small alteration may introduce noise. However, the amount of noise introduced is insufficient to completely modify the output of the quantum circuit or the obfuscated quantum circuit. In other words, the final state of the obfuscated quantum circuit, even if not identical, is a sufficient final state of the original quantum circuit.

Near-identity blocks can be created in different ways. In one example, a greedy approach may be performed. For example, a near-identity block may be generated with two-qubit gates, as illustrated in FIGS. 1A-1B in order to entangle qubits. If an attacker intends to modify the quantum circuit 100, the altered quantum circuit's output (probability distribution) will significantly diverge from its expected result, which hampers attempts to reverse engineer the obfuscated quantum circuit. Thus, even if an attacker has access to the obfuscated quantum circuit, the ability to make further developments and changes is hampered by the presence of the near-identity blocks. Making a change to the obfuscated quantum circuit generates a final state that is likely to be very different from a scenario where the same change is made to the original quantum circuit. Thus, the original quantum circuit is protected.

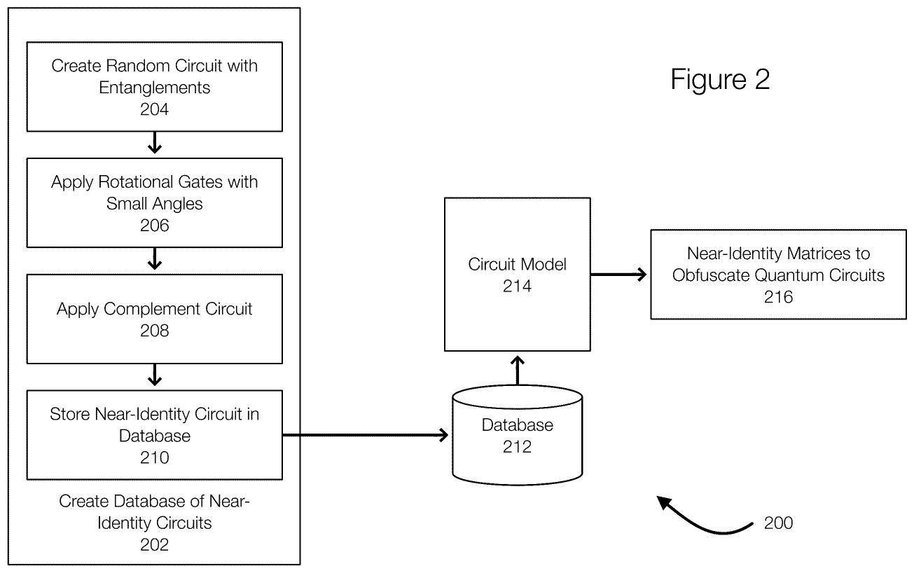

FIG. 2 discloses aspects of generating near-identity blocks (or circuits) for obfuscating quantum circuits. The method 200 generally includes creating 202 a database of near-identity circuits, which are used to train a model 214 (e.g., a generative adversarial network model or GAN model or other machine learning or ML-based model). The circuit model 214, once-trained, may generate blocks (e.g., near-identity matrices to obfuscate quantum circuits 260). In one example, a loss function may be used to reinforce that the generated circuit should be near to the identity by calculating the unitary matrix of the circuit and then penalizing, proportionally to its distance to an identity matrix. The model 214 may generate near-identity matrices to obfuscate quantum circuits. Obfuscating a quantum circuit may include adding these matrices to the quantum circuit (or algorithm). The inclusion of near-identity circuits can be considered from a gate perspective (e.g., FIGS. 1A-1B) or a mathematical perspective (e.g., identity matrices).

More specifically, a dataset of random circuits of arbitrary size with entanglements may be created 204. Rotational gates with small angles are applied 206 or added to these circuits. Next, a complement of the original random circuit is generated and applied 208. This results in a circuit that is a near-identity circuit. The near-identity circuits are stored 210 in a database 212. With reference back to FIG. 1A, the random circuit may be represented by the controlled not gate 126. Thus, the controlled not gate 126 is an example of creating 202 a random circuit with entanglements. Next, rotational gates, such as the rotational gates 128 are then applied 206 or added to the block or near-identity circuit. Next, a complement circuit, such as the controlled not gate 134 (e.g., a complement of the controlled not gate 124) is applied or added to the near-identity circuit. This results in a near-identity circuit (e.g., block 106a or 106b) that has been added to or inserted into the quantum circuit 100 being obfuscated.

In this manner, a database 212 of near-identity circuits are generated and may be used to train a circuit model 214. During its execution, the circuit model 214 may be used to generate blocks to be added to or inserted into a quantum circuit being obfuscated.

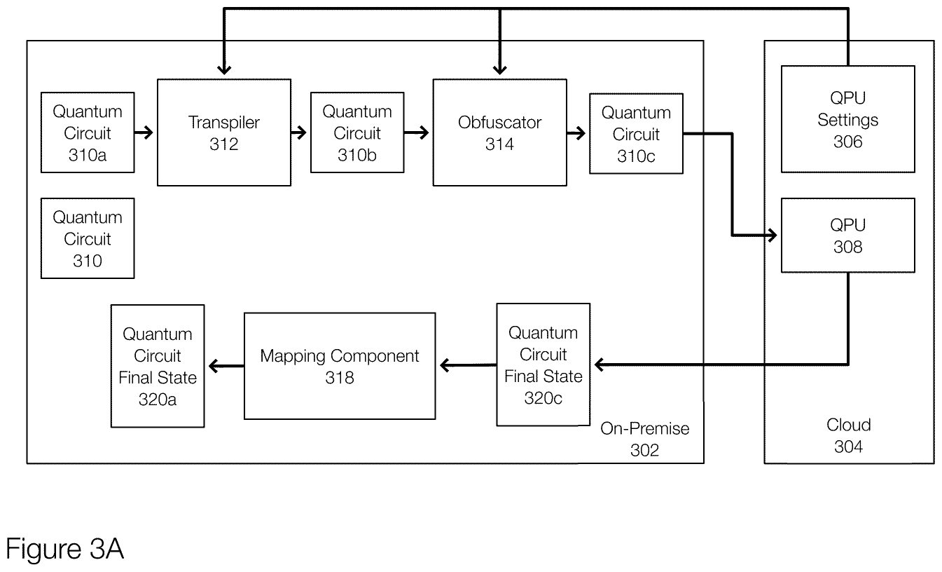

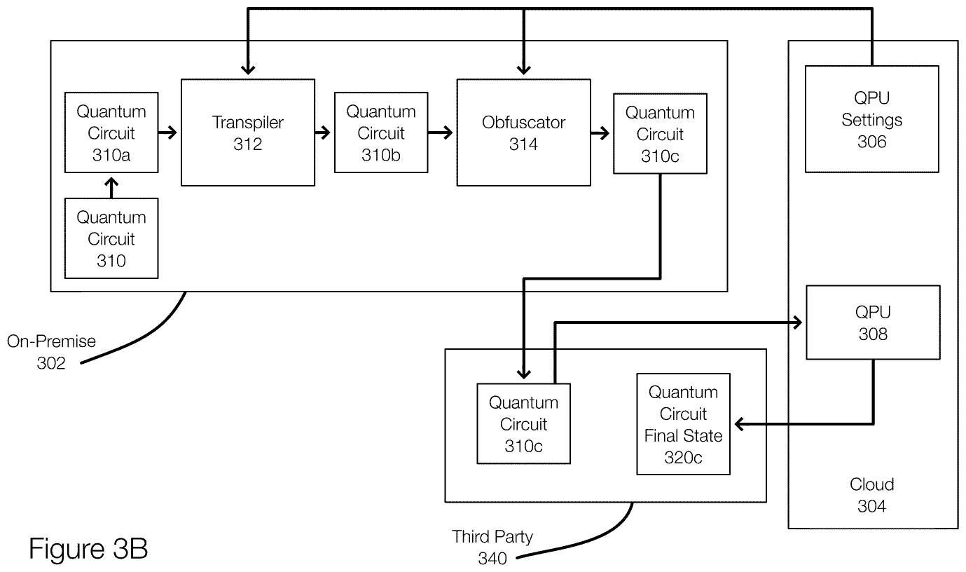

FIG. 3A discloses aspects of obfuscating a quantum circuit. FIG. 3A illustrates aspect of obfuscating a quantum circuit that may occur from an on-premise 302 perspective and a cloud perspective 304. FIG. 3A discusses a quantum circuit 310 at various stages, which are represented by quantum circuits 310a, 310b, and 310c. In this example, a quantum circuit 310a may be generated or developed by a practitioner. The quantum circuit 310a may be in the form of a quantum algorithm initially.

A transpiler 312 receives the quantum circuit 310a as input and generates a transpiled quantum circuit 310b. In one example, the transpiler 312 transforms or maps the quantum circuit 310a into a form suitable for the QPU 308 based in part on the QPU settings 306 (settings 306) of the QPU 308. The settings 306 may include, by way of example, basis gates, coupling map, noise model, qubits, and the like.

An obfuscator 314 is configured to receive the quantum circuit 310b as input and output an obfuscated quantum circuit 310c. The obfuscator 314 may add near-identity blocks (e.g., one or more) to the quantum circuit 310b. The quantum circuit 310c is sent to the cloud 304 and input to the QPU 308. In one example, obfuscation may occur in stages. Initially, the near-identity circuits may be added at random locations of the quantum circuit 310b (e.g., as illustrated in FIG. 1A). Next, the near-identity circuits are merged into the quantum circuit being obfuscated (e.g., as illustrated in FIG. 1B).

The quantum circuit 310c may be provided to a cloud 304 (e.g., a cloud provider of quantum execution) and more specifically for execution at a QPU 308 at least because the quantum circuit 310c was generated based on settings 306 of the QPU 308.

A final state 320c to the quantum circuit 310c is returned to the on-premise 302 from the cloud 304. A mapping component 318 may map the final state 320c to a final state 320a if necessary. For instance, if the obfuscator 314 changes the qubit layout of the quantum circuit 310b when generating the quantum circuit 310c, the mapping component 318 may map the final state 320c to the final state 320a. Generally, however, because the quantum circuit 310a is equivalent to the quantum circuit 310c, the final state 320c to the quantum circuit 310c suffices for the quantum circuit 310a.

FIG. 3B discloses additional aspects of obfuscating a quantum circuit. In the example of FIG. 3B, a third party 340 may be involved in the operations or processes of generating final states to quantum circuits. In this example, the third party 340 may be an entity assigned to evaluate the final state 320c. More specifically, the quantum circuit 310c is provided to the third party 340 and is subsequently input to the QPU 308. The final state 320c to the quantum circuit 310c is returned to the third party 340 and analyzed. Advantageously, the third party 340 does not have access to the quantum circuit 310a and the results or final state 320c are equivalent to the final state generated by the QPU 308 had the quantum circuit 310b been the input to the QPU 308.

Even if an attacker (or the third party 340) to the quantum circuit 310c, reverse engineering or de-obfuscating the quantum circuit 310c requires the attacker to remove all near-identity blocks added by the obfuscator 314. In other words, the attacker is required to find an equivalent circuit that produces the same output of the obfuscated circuit 310c. This requires trial-and-error attempts and multiple circuit simulations or real hardware usage, which can become expensive in computational time and cost.

The challenge in reverse engineering may be proportional to the number of near-identity blocks, their sizes, which can be different, and in their construction (e.g., used gates). Thus, reverse engineering can be made more difficult by inserting various combinations of near-identity circuits into the quantum circuit 310b.

Although an attacker may possess the obfuscated quantum circuit 310c, the original quantum circuit 310a is more desirable because the quantum circuit 310a (or 310b) can be executed on quantum computers with low-coherence times. Embodiments of the invention allow a practitioner to be aware of the coherence time modification when adding circuit blocks by the obfuscator 314. Further, building on the quantum circuit 310a cannot be achieved by simply building on the quantum circuit 310c at least due to the inclusion of the near-identity circuits.

The obfuscation operations of the obfuscator 314 may be used as an independent process that is deployed on-premise to clients. Further, obfuscation of quantum circuits can be done independently of any task on the on-premise side, which allows the obfuscator 314 to be implemented as-a-service.

Each near-identity block is constructed in a symmetrical manner such that it results in a near-approximate identity matrix using unitary properties of self-inversion (unitary matrices are their own inverse). More specifically, quantum states are often represented as vectors. Unitary matrices allow quantum operations to be reversed. Embodiments of the invention, however, include operations that may introduce noise at least because the change may not be completely reversible. For example, a rotation of 0.001 may have a very small impact that, from the perspective of the original quantum circuit, introduces noise. As previously stated, the noise is sufficiently small such that the final state to the obfuscated quantum circuit is a final state to the un-obfuscated quantum circuit. In one example, the generation of near-identity circuits (or blocks) includes generating an identity matrix, applying a slight modification in the block (e.g., in the middle of the matrix) that generates a slight divergence on the final equivalent unitary matrix. Embodiments of the invention attempt to minimize the amount of noise being added to such that the output is not modified in a manner to be unusable.

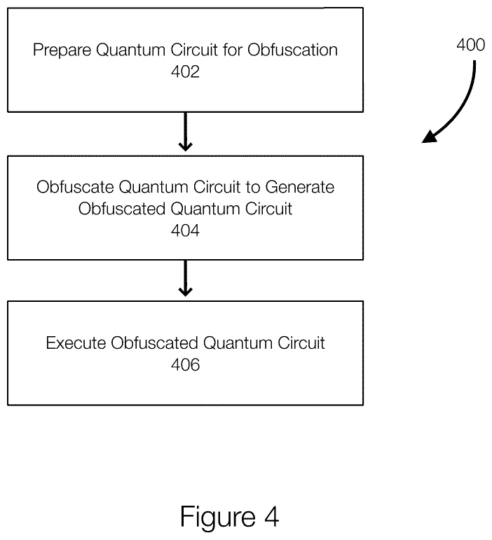

FIG. 4 discloses aspects of a method for obfuscating quantum circuits. The method 400 includes preparing 402 a quantum circuit for obfuscation. In one example, preparing the quantum circuit may include transpiling a quantum circuit to generate a transpiled quantum circuit. The transpiled quantum circuit is transpiled based on settings of a target QPU in one example.

After transpilation, the transpiled quantum circuit is obfuscated 404 to generate an obfuscated quantum circuit. Obfuscating 404 the transpiled quantum circuit may include requesting a model to generate one or more near-identity circuits (e.g., near-identity matrices) or retrieving one or more near-identity circuits from a database of near-identity circuits. More specifically, in one example, the near-identity circuit generated by the model may be based on characteristics of the circuit being obfuscated (e.g., gates, number of qubits, size).

More generally, obfuscating 404 the quantum may include the obfuscator inserting one or more near-identity circuits into the quantum circuit. The near-identity circuits may have different sizes. However, the near-identity circuits are configured to have minimal impact on the quantum circuit such that a final state to the obfuscated quantum circuit is sufficient or equivalent to the final state to the original quantum circuit. The number and size of the near-identity circuits may vary.

Obfuscating 404 the quantum circuit may also include merging the near-identity circuit into the layers of the original circuit such that execution of the near-identity circuit do not alter the behavior of the original quantum circuit. This may allow layers of the near-identity circuit to be aligned with or included in layers of the original quantum circuit. In other words, the quantum circuit may be rearranged to accommodate the blocks of the near-identity circuits.

Once the obfuscated quantum circuit is generated, the obfuscated quantum circuit may be executed 406 at a QPU (e.g., a selected or target QPU). The final state to the obfuscated quantum circuit produces the same final state to the original quantum circuit. Advantageously, the original quantum circuit is not exposed and the obfuscated quantum circuit is difficult and costly to reverse engineer.

Aspects of obfuscation may be performed by a computing device or system (e.g., processors, memory) such as servers or the like.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, near-identity circuit generation operations, quantum circuit obfuscation operations, quantum circuit execution operations, quantum circuit orchestration operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide functionality for one or more clients. Another example of a cloud computing environment is one in which processing, quantum circuit execution, data protection, and other, services may be performed on behalf of one or more clients. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example.

As used herein, the term ‘data’ is intended to be broad in scope.

Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method comprising: receiving a quantum circuit at a transpiler, transpiling the quantum circuit to generate a transpiled quantum circuit, obfuscating the transpiled quantum circuit to generate an obfuscated quantum circuit, wherein obfuscating the transpiled quantum circuit includes adding one or more near-identity circuits to the transpiled quantum circuit, and executing the obfuscated quantum circuit at a quantum processing unit to generate the same state of the un-obfuscated quantum circuit.

Embodiment 2. The method of embodiment 1, further comprising transpiling the quantum circuit based on settings of a target quantum processing unit.

Embodiment 3. The method of embodiment 1 and/or 2, wherein the settings include one or more of basis gates, a coupling map, a noise model, number of available qubits, or combinations thereof.

Embodiment 4. The method of embodiment 1, 2, and/or 3, wherein the one or more near-identity circuits are added to the transpiled quantum circuit with barriers to separate the one or more near-identity circuits from original content of the quantum circuit.

Embodiment 5. The method of embodiment 1, 2, 3, and/or 4, further comprising merging the one or more near-identity circuits into the quantum circuit, wherein merging includes associating layers of the one or more near-identity circuits with layers of the quantum circuit that are not affected by the one or more near-identity circuits.

Embodiment 6. The method of embodiment 1, 2, 3, 4, and/or 5, wherein noise introduced by the one or more near-identity circuits is not sufficient to prevent a final state of the obfuscated quantum circuit from being a final state of the quantum circuit.

Embodiment 7. The method of embodiment 1, 2, 3, 4, 5, and/or 6, wherein sizes of the one or more near-identity circuits added to the quantum circuit and locations of the near-identity circuits are random.

Embodiment 8. The method of embodiment 1, 2, 3, 4, 5, 6, and/or 7, wherein the one or more near-identity circuits comprise random circuits of arbitrary size with entanglements, rotational gates with small angles, and a complements of the random circuits.

Embodiment 9. The method of embodiment 1, 2, 3, 4, 5, 6, 7, and/or 8, further comprising generating the one or more near-identity circuits with a model trained on a database of near-identity circuits.

Embodiment 10. The method of embodiment 1, 2, 3, 4, 5, 6, 7, 8, and/or 9, wherein

a final state is generated by the quantum processing unit.

Embodiment 11. The method of embodiment 1, 2, 3, 4, 5, 6, 7, 8, 9, and/or 10, further comprising mapping the final state of the obfuscated quantum circuit to a final state of the quantum circuit when, during obfuscation, a qubit layer of the quantum circuit changed.

Embodiment 12 A system, comprising hardware and/or software, operable to perform any of the operations, methods, or processes, or any portion of any of these, disclosed herein.

Embodiment 13 A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

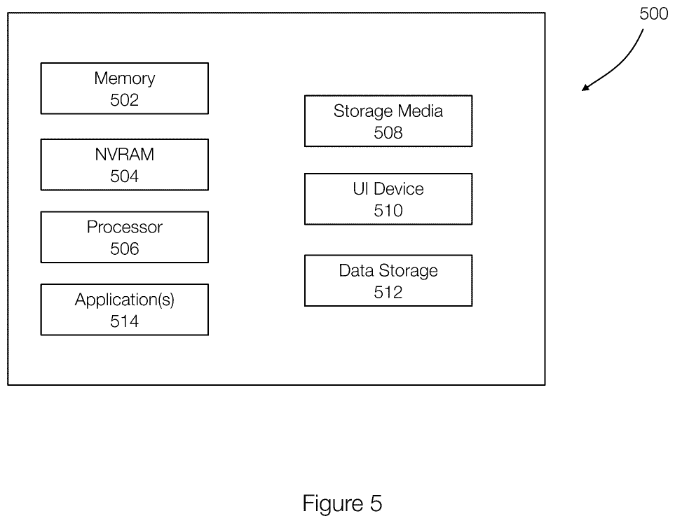

With reference briefly now to FIG. 5, any one or more of the entities disclosed, or implied, by the Figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may be configured to perform quantum operations as a simulated or emulated quantum processing unit. The device 500 may also be used in aspects of orchestrating the execution of a quantum circuit in a QPU, which may include obfuscating a quantum circuit to generate an obfuscated quantum circuit.

The described embodiments are to be considered in all respects only as illustrative and not restrictive. All changes which come within the meaning and range of equivalency of the claims are to be embraced within their scope.

What is claimed is:

1. A method comprising:
receiving a quantum circuit at a transpiler;
transpiling the quantum circuit to generate a transpiled quantum circuit;
obfuscating the transpiled quantum circuit to generate an obfuscated quantum circuit, wherein obfuscating the transpiled quantum circuit includes adding one or more near-identity circuits to the transpiled quantum circuit; and
executing the obfuscated quantum circuit at a quantum processing unit to generate a final state of the obfuscated quantum circuit.

2. The method of claim 1, further comprising transpiling the quantum circuit based on settings of a target quantum processing unit.

3. The method of claim 1, wherein the settings include one or more of basis gates, a coupling map, a noise model, number of available qubits, or combinations thereof.

4. The method of claim 1, wherein the one or more near-identity circuits are added to the transpiled quantum circuit with barriers to separate the one or more near-identity circuits from original content of the quantum circuit.

5. The method of claim 4, further comprising merging the one or more near-identity circuits into the quantum circuit, wherein merging includes associating layers of the one or more near-identity circuits with layers of the quantum circuit that are not affected by the one or more near-identity circuits.

6. The method of claim 5, wherein noise introduced by the one or more near-identity circuits is not sufficient to prevent a final state of the obfuscated quantum circuit from being a final state of the quantum circuit.

7. The method of claim 6, wherein sizes of the one or more near-identity circuits added to the quantum circuit and locations of the one or more near-identity circuits are random.

8. The method of claim 1, wherein the one or more near-identity circuits comprise random circuits of arbitrary sizes with entanglements, rotational gates with small angles, and complements of the random circuits.

9. The method of claim 8, further comprising generating the one or more near-identity circuits with a machine learning model trained on a database of near-identity circuits.

10. The method of claim 1, wherein a final state is generated by the quantum processing unit.

11. The method of claim 10, further comprising mapping the final state of the obfuscated quantum circuit to a final state of the quantum circuit when, during obfuscation, a qubit layer of the quantum circuit changed.

12. A non-transitory storage medium having stored therein instructions that are executable by one or more hardware processors to perform operations comprising:
receiving a quantum circuit at a transpiler;
transpiling the quantum circuit to generate a transpiled quantum circuit;
obfuscating the transpiled quantum circuit to generate an obfuscated quantum circuit, wherein obfuscating the transpiled quantum circuit includes adding one or more near-identity circuits to the transpiled quantum circuit; and
causing execution of the obfuscated quantum circuit at a quantum processing unit to generate a final state of the obfuscated quantum circuit.

13. The non-transitory storage medium of claim 12, further comprising transpiling the quantum circuit based on settings of a target quantum processing unit, wherein the settings include one or more of basis gates, a coupling map, a noise model, number of available qubits, or combinations thereof.

14. The non-transitory storage medium of claim 12, wherein the one or more near-identity circuits is added to the transpiled quantum circuit with barriers to separate the one or more near-identity circuits from original content of the quantum circuit, further comprising merging the one or more near-identity circuits into the quantum circuit, wherein merging includes associating layers of the one or more near-identity circuits with layers of the quantum circuit that are not affected by the near-identity circuit.

15. The non-transitory storage medium of claim 14, wherein noise introduced by the one or more near-identity circuits is not sufficient to prevent a final state of the obfuscated quantum circuit from being a final state of the quantum circuit.

16. The non-transitory storage medium of claim 15, wherein sizes of the one or more near-identity circuits added to the quantum circuit and locations of the one or more near-identity circuits are random.

17. The non-transitory storage medium of claim 12, wherein the one or more near-identity circuits comprise random circuits of arbitrary size with entanglements, rotational gates with small angles, and complements of the random circuits.

18. The non-transitory storage medium of claim 17, further comprising generating the one or more near-identity circuits with a machine learning model trained on a database of near-identity circuits.

19. The non-transitory storage medium of claim 12, wherein a final state is generated by the quantum processing unit.

20. The non-transitory storage medium of claim 19, further comprising mapping the final state to the obfuscated quantum circuit to a final state of the quantum circuit when, during obfuscation, a qubit layer of the quantum circuit changed.
